(19) United States
(12) Patent Application Publication
(10) Pub. No.: US 2007/0146837 A1
(43) Pub. Date: Jun. 28, 2007

(54) Holographic recording medium

(75) Inventors: Hiroshi Sakamoto, Ibaraki-shi (JP); Atsushi Sato, Ibaraki-shi (JP)

Correspondence Address: OLIFF & BERRIDGE, PLC, P.O. BOX 19928, ALEXANDRIA, VA, 22320, US

(73) Assignee: Hitachi Maxell, Ltd., Ibaraki-shi (JP)

(21) Appl. No.: 11/635,527

(22) Filed: Dec. 8, 2006

(30) Foreign Application Priority Data
Dec. 9, 2005 (JP) 2005-355797

(51) Int. Cl. G03H 1/02

(52) U.S. Cl. 359/3; 359/1

(57) ABSTRACT

A holographic data storage medium is provided, which includes a first substrate; a second substrate which has a dimension larger than that of the first substrate; and a holographic-recording layer which is provided between the first substrate and the second substrate; wherein the second substrate has a support portion which is disposed outside the first substrate and which is supported by the recording/reading apparatus. The holographic data storage medium makes it possible to realize the miniaturization and the optimization of the structure of the holographic data storage medium having an outer edge portion to be held in a recording/reading apparatus and to record and reconstruct information more correctly.

### BACKGROUND OF THE INVENTION

1. Field of the Invention

The present invention relates to a holographic recording medium.

2. Description of the Related Art

A variety of techniques, which relate to the realization of the miniaturization and the high density recording of the information-recording medium, have been hitherto suggested in order to increase the amount of information per volume. In particular, in recent years, the attention is directed to the holographic data storage medium which has the features of the high recording capacity, the high transfer rate, and the capability of random access.

In the case of the holographic data storage medium (holographic recording medium), unlike the traditional optical disk, two light beams (signal/object beam and reference beam) are radiated onto the recording layer (holographic-recording layer) to form a hologram (an interference pattern) of the signal beam and the reference beam in the thickness direction of the holographic-recording layer, thereby recording the information. The hologram can be changed, for example, by changing the angle between the signal beam and the reference beam. Therefore, it is possible to superimpose different holograms in a predetermined area, thereby achieving the high density recording. When the reference beam is radiated onto the recorded information (hologram) while changing the angle of the reference beam, then the hologram, which corresponds to the angle of the reference beam, is detected, and the information is reconstructed (reproduced).

As for the structure of the holographic data storage medium, a medium is known, which has the sandwich structure in which a recording layer is sandwiched between two substrates (see, for example, Japanese Patent Application Laid-open No. 2005-17589). In the case of the holographic data storage medium of this structure, a material which mixtures two liquids is used for the recording layer in many cases.

When the information is recorded and reconstructed to the holographic data storage medium, the holographic data storage medium is usually used by being inserted into an exclusive recording/reading (recording/reproducing) apparatus. A positioning unit is provided in the recording/reading apparatus in order to correctly record and reconstruct the information. When the holographic data storage medium is loaded to the recording/reading apparatus, the holographic data storage medium is held, for example, by the positioning unit to perform the recording and reading. The following example is also known as a stacked waveguide type hologram. That is, an optical memory element is loaded to a casing (cartridge) which is one size larger than the optical memory element, and the positioning is performed by using the casing (see, for example, Japanese Patent Application Laid-open No. 2004-103196).

The holographic data storage medium is adaptable to a variety of applications, because the holographic data storage medium has the features of the high recording capacity, the high transfer rate, and the capability of random access as described above. Therefore, the attention is enhanced to the holographic data storage medium. It is demanded to further miniaturize and optimize the structure of the holographic data storage medium.

### SUMMARY OF THE INVENTION

As described above, the information is recorded on the holographic data storage medium by forming the hologram of the signal beam and the reference beam in the thickness direction of the holographic-recording layer. Therefore, the recording and reconstructing (reproducing) characteristics of the holographic data storage medium are apt to vary by the external force and the like. Therefore, it is necessary to protect the holographic-recording layer from the external force and the like as much as possible.

The present invention has been made in order to respond to the request as described above. An object of the present invention is to provide a holographic data storage medium in which the structure of the holographic data storage medium is optimized so that the holographic data storage medium can be adapted to a variety of applications, and in which the information can be recorded and reconstructed more correctly. In particular, in a holographic data storage medium in which an outer edge portion thereof is held when the holographic data storage medium is loaded to a recording/reading apparatus, it is intended to provide the holographic data storage medium in which the structure is intended to be optimized and miniaturized, and in which the information can be recorded and reconstructed more correctly.

According to a first aspect of the present invention, there is provided a holographic data storage medium (holographic recording medium) which is loaded to a recording/reading apparatus for recording and reconstructing information; the holographic data storage medium comprising a first substrate; a second substrate which has a dimension larger than that of the first substrate; and a holographic-recording layer which is provided between the first substrate and the second substrate; wherein the second substrate has a support portion which is outside the first substrate and which is supported by the recording/reading apparatus.

In the holographic data storage medium according to the first aspect of the present invention, the support portion may be disposed on each of both surfaces of the second substrate.

The term “holographic data storage medium (holographic recording medium)” referred to in this specification includes not only the medium which has the two substrates and the holographic-recording layer provided therebetween (hereinafter referred to as “data storage medium body” as well) but also the medium which has the data storage medium body and a cartridge for holding the data storage medium body as described later on.

The term “support portion supported by the recording/reading apparatus” referred to in this specification means the portion which is supported directly or indirectly by applying the pressure or the like by means of any support unit (positioning unit or the like) included in the recording/reading apparatus when the holographic data storage medium is loaded to the recording/reading apparatus. Examples of the support effected by applying the pressure or the like indirectly include, for example, the case in which the support is effected by applying the pressure to the support portion of the second substrate via a cartridge or the like as described later on. In the present invention, when the both surfaces of the second substrate are supported by the support unit included in the recording/reading apparatus, then the both surfaces may be directly supported by means of the support unit, or the both surfaces may be indirectly supported. Alternatively, the support portion of one surface of the second substrate may be directly supported by means of the support unit, and the support portion of the other surface may be indirectly supported.

Usually, when the holographic data storage medium is loaded to the recording/reading apparatus, the holographic data storage medium is held or retained at a predetermined position by means of the support unit such as the positioning unit in the recording/reading apparatus. Those usable as the support unit include, for example, pin and spring. The holographic data storage medium is supported at the predetermined position, for example, by the pressure (elastic force) of the support unit. Therefore, it is feared that the pressure may be applied to the holographic-recording layer sandwiched between the two substrates, and any strain appears in the holographic-recording layer, depending on the support method and the structure of the support unit. When the strain arises in the holographic-recording layer, it is impossible to correctly record and reconstruct the information, because the hologram of the holographic-recording layer is varied.

In the case of the holographic data storage medium provided with the cartridge for holding the data storage medium body wherein the cartridge is held by the support unit, it is also feared that the pressure may be applied to the holographic-recording layer when the holographic data storage medium is loaded into the recording/reading apparatus, and any strain may appear in the holographic-recording layer, depending on the support method and the structure of the support unit. Further, it is also feared that the pressure may be applied to the holographic-recording layer at the point of time at which the data storage medium body is held by the cartridge, depending on the structure of the cartridge. Furthermore, when any thermal change arises in the external environment, it is also feared that the deformation of the recording medium body to be caused by the thermal expansion or contraction may be suppressed by the cartridge, and the deformation to be caused by the stress may arise in the holographic-recording layer, depending on the structure of the cartridge (for example, in the case of such a structure that the data storage medium body is completely covered). As described above, in the case of the holographic data storage medium provided with the cartridge for holding the data storage medium body, it is also feared that the deformation due to the stress may arise in the holographic-recording layer, and there is such a possibility that the erroneous recording and the erroneous reconstruction of information may be caused.

The present invention has been made in order to solve the problems as described above. The holographic data storage medium of the present invention has the following structure. That is, one substrate (second substrate), which is included in the two substrates, has the dimension which is larger than that of the other substrate (first substrate). When the holographic data storage medium is loaded to the recording/reading apparatus, at least a part (support portion) of the second substrate, which protrudes to the outside from the first substrate, is supported, for example, by the positioning unit of the recording/reading apparatus. In the case of the holographic data storage medium of the present invention, only the second substrate is supported in the recording/reading apparatus. Therefore, when the holographic data storage medium is loaded to the recording/reading apparatus, no pressure is applied to the holographic-recording layer which is sandwiched between the two substrates. Therefore, no strain arises in the holographic-recording layer. Accordingly, the information can be recorded and reconstructed more correctly.

In the case of the holographic data storage medium according to the first aspect of the present invention, it is enough to provide such a structure that only the second substrate is supported when the holographic data storage medium is loaded to the recording/reading apparatus. Therefore, it is not necessarily indispensable to provide any cartridge which covers the data storage medium body. Therefore, it is also possible to realize the miniaturization of the holographic data storage medium according to the first aspect of the present invention.

Considering the protection of the holographic-recording layer and the easiness of the handling of the holographic data storage medium, the holographic data storage medium according to the first aspect of the present invention further may include a cartridge which holds the second substrate. In the case of the holographic data storage medium provided with the cartridge having the structure as described above, no pressure is directly applied to the holographic-recording layer sandwiched between the two substrates, even when any pressure is applied to the cartridge by the support unit such as the positioning unit when the holographic data storage medium is loaded to the recording/reading apparatus, because the cartridge holds only the second substrate in this structure. Therefore, no strain arises in the holographic-recording layer. Accordingly, it is possible to record and reconstruct the information more correctly.

In the holographic data storage medium according to the first aspect of the present invention, a hold portion, which is to be held by the cartridge, may be provided at an outer edge portion of the second substrate, the hold portion may have a thickness which is thinner than a thickness of a central portion of the second substrate, a surface of the hold portion, which is disposed on a side opposite to a side of the holographic-recording layer, may be located nearer to the holographic-recording layer than a surface of the central portion of the second substrate, which is disposed on the side opposite to the side of the holographic-recording layer, and both surfaces of the hold portion may be held by the cartridge.

In the case of the holographic data storage medium according to the first aspect of the present invention, only one surface of the outer edge portion of the second substrate may be held by the cartridge. However, in this construction, when any force (for example, impact or vibration) is applied from the side of the surface subjected to the holding, it is also feared that the second substrate may be disengaged from the cartridge. Therefore, in order to improve the durability of the holographic data storage medium against the impact, the vibration or the like and realize the stable recording and reconstruction, the both surfaces of the outer edge portion of the second substrate may be held by the cartridge. In this case, when the structure is provided such that the thickness of the portion (hold portion) of the second substrate, which is held or retained by the cartridge is thinned, and the surface of the hold portion, which is disposed on the side opposite to the side of the holographic-recording layer, is located nearer to the holographic-recording layer than the surface of the central portion of the second substrate, which is disposed on the side opposite to the side of the holographic-recording layer, then it is also possible to thin the thickness of the cartridge, and it is possible to realize the miniaturization of the holographic data storage medium.

In the holographic data storage medium according to the first aspect of the present invention, a surface of a central portion of the second substrate, which is disposed on a side opposite to a side of the holographic-recording layer, may be flush with an outermost surface of the cartridge which is disposed on a side of the second substrate. When such a structure is adopted, it is possible to provide approximately the same thickness of the cartridge as that of the data storage medium body. Therefore, it is possible to realize the miniaturization of the holographic data storage medium. In the holographic data storage medium of the present invention, it may be also allowable to adopt the following structure. That is, the surface of the second substrate, which is disposed on the side opposite to the side of the holographic-recording layer, may not be flush with the outermost surface of the cartridge which is disposed on the side of the second substrate, and the surface of the second substrate, which is disposed on the side opposite to the side of the holographic-recording layer, may be located nearer to the holographic-recording layer than the outermost surface of the cartridge which is disposed on the side of the second substrate. When such a structure is adopted, the second substrate does not make any direct contact with a desk or the like, for example, even when the holographic data storage medium is placed on the desk or the like. Therefore, it is possible to improve the protective performance of the holographic-recording layer.

In the holographic data storage medium according to the first aspect of the present invention, the recording/reading apparatus may include a recording/reading head which records and reconstructs the information on the holographic data storage medium, and the second substrate may be located on a side of the recording/reading head when the holographic data storage medium is loaded to the recording/reading apparatus. As described above, in the case of the holographic data storage medium of the present invention, the second substrate is held when the holographic data storage medium is loaded to the recording/reading apparatus. Therefore, the second substrate becomes the reference of the positioning in the thickness direction of the holographic data storage medium. Therefore, when the recording/reading head is positioned on the side of the second substrate, it is possible to more correctly adjust the focus position of the light beam to be radiated onto the holographic-recording layer.

According to a second aspect of the present invention, there is provided a holographic data storage medium which is loaded to a recording/reading apparatus for recording and reconstructing information; the holographic data storage medium including a first substrate; a second substrate which has a dimension larger than that of the first substrate; a holographic-recording layer which is provided between the first substrate and the second substrate; and a cartridge which holds the second substrate; wherein the cartridge has a support portion which supports the holographic data storage medium in the recording/reading apparatus.

In the case of the holographic data storage medium according to the second aspect of the present invention, the support portion of the cartridge is supported when the holographic data storage medium is loaded to the recording/reading apparatus. Therefore, no pressure is directly applied to the holographic-recording layer and the first and second substrates which sandwich the holographic-recording layer. Therefore, no strain arises in the holographic-recording layer. Therefore, it is possible to record and reconstruct the information more correctly.

In the holographic data storage medium of the present invention, a surface of the first substrate, which is disposed on a side opposite to a side of the holographic-recording layer, may be located nearer to the holographic-recording layer than an outermost surface of the cartridge which is disposed on a side of the first substrate.

In the holographic data storage medium of the present invention, the first substrate may make no contact with the recording/reading apparatus when the holographic data storage medium is loaded to the recording/reading apparatus. In the holographic data storage medium of the present invention, the first substrate may make no contact with the cartridge. In the holographic data storage medium of the present invention, the cartridge may hold only the second substrate.

According to the holographic data storage medium concerning the first aspect of the present invention, only the portion, of the second substrate, which protrudes to the outside of the first substrate, i.e., the support portion of the second substrate is supported in the recording/reading apparatus, when the holographic data storage medium is loaded to the recording/reading apparatus. Therefore, no pressure is applied to the holographic-recording layer which is sandwiched between the two substrates. Therefore, no strain arises in the holographic-recording layer. It is possible to record and reconstruct the information more correctly.

According to the holographic data storage medium concerning the first aspect of the present invention, it is possible to provide such a structure that the second substrate is directly supported when the holographic data storage medium is loaded to the recording/reading apparatus. In this construction, it is not necessarily indispensable to provide the cartridge for holding the data storage medium body. In the case of the holographic data storage medium of the present invention, the thickness of the cartridge can be thinned as described above even when the holographic data storage medium has the cartridge. Therefore, in the case of the holographic data storage medium of the present invention, it is also possible to realize the miniaturization.

According to the holographic data storage medium concerning the second aspect of the present invention, only the support portion of the cartridge is supported in the recording/reading apparatus when the holographic data storage medium is loaded to the recording/reading apparatus. Therefore, no pressure is directly applied to the holographic-recording layer as well as to the first and second substrates which sandwich the holographic-recording layer. Therefore, no strain arises in the holographic-recording layer. Therefore, it is possible to record and reconstruct the information more correctly.

### BRIEF DESCRIPTION OF THE DRAWINGS

FIGS. 1A and 1B show an arrangement of a holographic data storage medium of a first embodiment, wherein FIG. 1A shows a plan view, and FIG. 1B shows a side view.

FIGS. 2A and 2B show the arrangement of the holographic data storage medium body of the first embodiment, wherein FIG. 2A shows a side view, and FIG. 2B shows a plan view as viewed from a side of a first substrate.

FIG. 3 shows a sectional view illustrating the holographic data storage medium of the first embodiment, taken along a line III-III shown in FIG. 1.

FIGS. 4A and 4B show an arrangement of a recording/reading apparatus used in the first embodiment, wherein FIG. 4A shows a perspective view, and FIG. 4B shows a side view as viewed from a side of an insert port for inserting the holographic data storage medium.

FIGS. 5A and 5B show situations in which the holographic data storage medium of the first embodiment is loaded to the recording/reading apparatus, wherein FIG. 5A shows the situation before the loading, and FIG. 5B shows the situation after the loading.

FIGS. 6A and 6B show situations in the recording/reading apparatus in which the holographic data storage medium of the first embodiment is loaded to the recording/reading apparatus, wherein FIG. 6A shows a sectional view taken along a line VIA-VIA shown in FIG. 5B, and FIG. 6B shows a sectional view taken along a line VIB-VIB shown in FIG. 5B.

FIG. 7 shows a side view illustrating a holographic data storage medium of a first modified embodiment.

FIG. 8 shows a sectional view illustrating a holographic data storage medium of a second modified embodiment.

FIG. 9 shows a sectional view illustrating a holographic data storage medium of a third modified embodiment.

FIG. 10 shows a situation in a recording/reading apparatus in which the holographic data storage medium of the third modified embodiment is loaded to the recording/reading apparatus.

FIG. 11 shows a sectional view illustrating a holographic data storage medium of a fourth modified embodiment.

FIG. 12 shows a sectional view illustrating a holographic data storage medium of a fifth modified embodiment.

FIGS. 13A to 13C show schematic arrangements of holographic data storage media of a sixth modified embodiment, wherein FIGS. 13A and 13C show plan views illustrating the holographic data storage media of the sixth modified embodiment as viewed from the side of the first substrate, and FIG. 13B shows a side view of FIG. 13A.

### DESCRIPTION OF THE PREFERRED EMBODIMENTS

Embodiments of the holographic data storage medium according to the present invention will be specifically explained below with reference to the drawings. However, the present invention is not limited thereto.

### First Embodiment

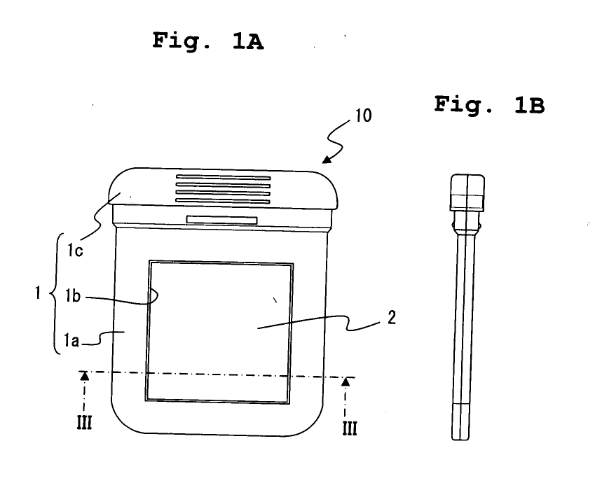

FIGS. 1A and 1B show a schematic arrangement of a holographic data storage medium of a first embodiment. FIG. 1A shows a plan view illustrating the holographic data storage medium of this embodiment, and FIG. 1B shows a side view. As shown in FIG. 1A, the holographic data storage medium 10 of this embodiment includes a cartridge 1 and a data storage medium body 2. The holographic data storage medium 10 of this embodiment is such a holographic data storage medium that the outer edge portion thereof is supported by the support unit such as the positioning unit of a recording/reading apparatus when the holographic data storage medium 10 is loaded to the recording/reading apparatus.

As shown in FIG. 1A, the cartridge 1 has a substantially flat plate-shaped form, and includes an insert portion 1a which is to be inserted into the recording/reading apparatus (to be as described later on), and a gripping portion or carrying portion 1c which is to be gripped by a user when the medium is inserted into the recording/reading apparatus. A square through-hole 1b, which penetrates in the thickness direction of the insert portion 1a, is formed at a central portion of the insert portion 1a. The through-hole 1b has approximately the same shape and dimension as those of a second substrate 22 of the after-mentioned data storage medium body 2. The data storage medium body 2 is held by side walls for defining the through-hole 1b. As shown in FIG. 1B, the thickness of the carrying portion 1c is thicker than the thickness of the insert portion 1a so that the user is capable of carrying the medium with ease. Therefore, the holographic data storage medium 10 of this embodiment has a substantially T-shaped form as shown in FIG. 1B when the holographic data storage medium 10 of this embodiment is viewed in the side view.

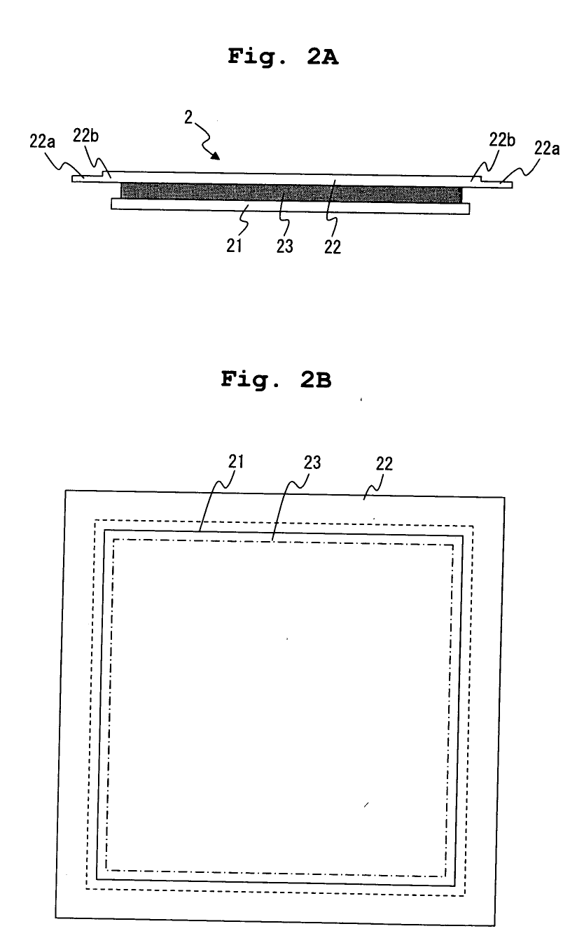

FIGS. 2A and 2B show a schematic arrangement of the data storage medium body 2. FIG. 2A shows a side view illustrating the data storage medium body 2 of this embodiment, and FIG. 2B shows a plan view of the data storage medium body 2 as viewed from the side of an after-mentioned first substrate 21. As shown in FIG. 2A, the data storage medium body 2 includes the first substrate 21, the second substrate 22 which has the dimension that is larger than the dimension of the first substrate 21, and a holographic-recording layer 23 which is formed between the first substrate 21 and the second substrate 22.

As shown in FIGS. 2A and 2B, the first substrate 21 is a square plate-shaped member. In this embodiment, the first substrate 21 was formed of an amorphous olefin resin. The dimension of the first substrate 21 was 25 mm×25 mm×1 mm.

As shown in FIGS. 2A and 2B, the second substrate 22 is a square plate-shaped member. In this embodiment, the second substrate 22 was formed of an amorphous olefin resin in the same manner as the first substrate 21. The dimension of the second substrate 22 was 30 mm×30 mm×1 mm. A difference in height (step portion) was provided at the outer edge portion of the surface of the second substrate 22, which is disposed on the side opposite to the side of the first substrate 21 (the thickness of outer edge portion of the second substrate 22 was made thinner than the thickness of the central portion of the second substrate 22). It is preferable that the thickness of the step portion 22a is approximately the same thickness as that of an engage portion 1e of the cartridge 1. In this embodiment, the thickness of the step portion 22a was about 0.5 mm. The step portion 22a is to be held by the side wall portions which define the through-hole 1b of the cartridge 1 when the data storage medium body 2 is loaded to the cartridge 1 as described later on. In this embodiment, the upper and lower surfaces of the step portion are held by the cartridge 1. The step portion 22a of the second substrate 22, which has the thin thickness, is herein referred to as “hold portion 22a”. The shape of the hold portion 22a is arbitrary provided that the upper and lower surfaces of the hold portion 22a are held by the cartridge 1. The shape of the hold portion 22a can be appropriately changed depending on, for example, application or purpose and the holding structure of the recording/reading apparatus. For example, it is also allowable to provide a tapered shape so that the thickness of the hold portion 22a is gradually thinned in the direction directed toward the outer circumferential end of the second substrate 22. Alternatively, it is also allowable to provide no step or no difference in height (the thickness of the hold portion 22a is the same as the thickness of the central portion of the second substrate 22) in some cases. The portion 22b (hereinafter referred to as “support portion 22b” as well), which is located outside the area of the second substrate 22 opposed to the first substrate 21 as shown in FIG. 2A and which are disposed adjacently to the hold portion 22a, serve as the portion which is to be directly and indirectly supported by guide pin 32 and plate spring 33 provided in the recording/reading apparatus when the holographic data storage medium 10 is loaded to the recording/reading apparatus as described later on.

The holographic-recording layer 23 was formed of a photosensitive polymer. The dimension of the holographic-recording layer 23 was 24 mm×24 mm×1.5 mm. That is, the holographic-recording layer 23 was formed so that the dimension of each of the upper and lower surfaces of the holographic-recording layer 23 was slightly smaller than the dimension of each of the upper and lower surfaces of the first substrate 21.

As shown in FIGS. 2A and 2B, the data storage medium body 2 of this embodiment was formed so that the respective centers of the first substrate 21, the second substrate 22, and so that the holographic-recording layer 23 were aligned coaxially, and the outer edge portions of the second substrate 22, which protruded from the first substrate 21, had equivalent widths.

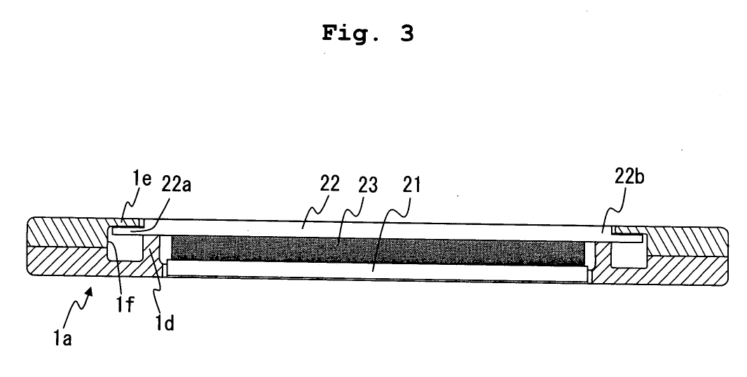

FIGS. 1A and 1B show the entire arrangement in which the data storage medium body 2 is loaded to the cartridge 1. FIG. 3 shows a cross section taken along a line III-III shown in FIG. 1A. As shown in FIG. 3, the holographic data storage medium of this embodiment has such a structure that the side wall portions for defining the through-hole 1b of the cartridge 1 hold the hold portion 22a formed at the outer edge portions of the data storage medium body 2. That is, in this structure, only the second substrate 22 is held by the cartridge. This feature will be specifically explained. As shown in FIG. 3, a recess 1f, which extends along the outer edge of the through-hole 1b, is formed on the side wall portion which defines the through-hole 1b of the cartridge 1 and which faces the side surface of the data storage medium body 2. A projection 1d, which protrudes toward the engage portion 1e of the cartridge 1, is formed on the lower side surface of the recess 1f. The projection 1d extends along the outer edge of the through-hole 1b. The recess referred to herein is meant to include not only the space defined by the side surfaces and the bottom surface but also the side surfaces and the bottom surface which define the recess. As shown in FIG. 3, when the data storage medium body 2 is loaded to the cartridge 1, the upper surface of the hold portion 22a of the second substrate 22 is supported by the lower surface of the engage portion 1e of the cartridge 1, and the lower surface of the support portion 22b of the second substrate 22 is supported by the upper surface of the projection 1d formed on the lower side surface of the recess 1f. That is, in this embodiment, the outer edge portion (the area including the hold portion 22a and the support portion 22b) of the second substrate 22 of the data storage medium body 2 is held by being sandwiched between the engage portion 1e of the cartridge 1 and the projection 1d formed on the lower side surface of the recess 1f.

As shown in FIG. 3, the holographic data storage medium 10 of this embodiment has the structure in which only the second substrate 22 is held by the cartridge 1. In this structure, the first substrate 21 and the cartridge 1 make no direct contact (no contact) with each other. Further in the holographic data storage medium of this embodiment, the lower surface of the first substrate 21 is located nearer to the holographic-recording layer 23 than the lower surface of the cartridge 1 (the lower surface of the cartridge 1 is not flush with the lower surface of the first substrate 21). That is, the holographic data storage medium 10 of this embodiment has such the structure that when the holographic data storage medium 10 is loaded to the recording/reading apparatus 30, the recording/reading apparatus 30 and the first substrate 21 are in the state of making no contact with each other. This structure was adopted by the following reason. It is intended that the plate spring 33 and the first substrate 21 make no contact with each other so that no pressure is applied to the first substrate 21 (holographic-recording layer 23), when the holographic data storage medium 10 is loaded to the recording/reading apparatus 30 and the lower surface of the cartridge 1 is supported by the plate spring 33, as described later on. It is preferable that the step or the difference in height between the lower surface of the first substrate 21 and the lower surface of the cartridge 1 is about 0.1 to 0.6 mm. In this embodiment, the step was 0.1 to 0.2 mm.

As described above, in this embodiment, the whole data storage medium body 2 is held by the cartridge 1 by holding only the second substrate 22 of the data storage medium body 2 by means of the cartridge 1. Therefore, this embodiment does not have such a structure that the holographic-recording layer 23 is directly held by the cartridge 1. Therefore, even when the data storage medium body 24 is loaded to the cartridge 1, then no pressure is applied to the holographic-recording layer 23, and no stress arises as well.

In this embodiment, as shown in FIG. 3, the outer edge portion of the second substrate 22 is held so that the outer edge portion of the second substrate 22 is sandwiched by the upper and lower side surfaces of the recess 1f formed at the side wall portion for defining the through-hole 1b of the cartridge 1. Therefore, even when any external force (for example, vibration or impact) is applied from the upper surface side or the lower surface side of the holographic data storage medium 10, the data storage medium body 2 is not disengaged from the cartridge 1. Therefore, in the case of the holographic data storage medium 10 of this embodiment, it is possible to improve the durability, for example, against the vibration and the impact. It is possible to stably record and reconstruct the information.

Further, in this embodiment, the hold portion 22a having the thin thickness is formed at the outer edge portion of the second substrate 22. Therefore, as shown in FIG. 3, the upper surface of the cartridge 1 and the upper surface of the second substrate 22 can be made flush with each other. Therefore, in this embodiment, it is possible to thin the thickness of the cartridge 1, and it is possible to realize the miniaturization of the holographic data storage medium 10.

The data storage medium body 2 of this embodiment was manufactured as follows. At first, the photosensitive polymer which was the above-mentioned material for forming the holographic-recording layer 23 is applied on the first substrate 21. The second substrate 22 was placed on the applied resin, and the resin was cured while maintaining the parallelism between the first substrate 21 and the second substrate 22 to form the holographic-recording layer 23. In the case of the holographic data storage medium of the present invention, as necessary, a reflective layer may be formed on one of the first and second substrates. Alternatively, an anti-reflective layer may be formed on both of the first and second substrates. However, the positions, at which the reflective layer and the anti-reflective layer are formed, are arbitrary, which may be appropriately changed depending on, for example, the application or purpose.

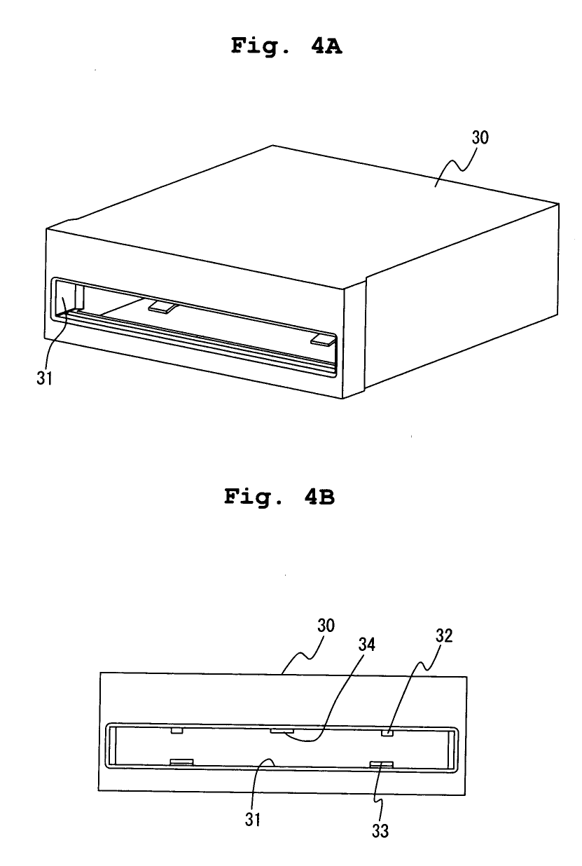

Next, an explanation will be made with reference to FIGS. 4 to 6 about the recording/reading apparatus used in this embodiment and about situations in which the holographic data storage medium 10 is loaded to the recording/reading apparatus. FIGS. 4A and 4B show a schematic arrangement of the recording/reading apparatus used in this embodiment. FIG. 4A shows a perspective view illustrating the recording/reading apparatus, and FIG. 4B shows a side view as viewed from a side of an insert port 31 for inserting the holographic data storage medium. FIGS. 4A and 4B show a state in which the insert port 31 is open.

The insert port 31 is provided on one side surface of the recording/reading apparatus 30 of this embodiment. The holographic data storage medium 10 is loaded and unloaded via the insert port 31. The width and the height of the insert port 31 were larger than the width and the thickness of the insert portion 1a of the holographic data storage medium 10 respectively. Further, the width and the height of the insert port 31 were smaller than the width and the thickness of the gripping portion 1c respectively.

As shown in FIG. 4B, the recording/reading apparatus 30 of this embodiment has a pair of guide pins 32 and a pair of plate springs 33 (positioning unit) which are provided therein in order to hold the inserted holographic data storage medium 10. Both of the pair of guide pins 32 and the pair of plate springs 33 are arranged at intervals which are approximately the same as the width of the second substrate 22 of the holographic data storage medium 10. Further, the pair of guide pins 32 and the pair of plate springs 33 are arranged so that the guide pins 32 and the plate springs 33 are opposed to one another. When the holographic data storage medium 10 is loaded to the recording/reading apparatus 30, the upper and lower surfaces of the holographic data storage medium 10 are sandwiched between the pair of guide pins 32 and the pair of plate springs 33. The holographic data storage medium 10 is pressed against the guide pins 32 by means of the elastic force of the plate springs 33, and thus the holographic data storage medium 10 is supported. Therefore, the position, at which the holographic data storage medium is supported by the guide pins 32, is the reference position of the holographic data storage medium 10 in the thickness direction when the information is recorded and reconstructed. As shown in FIG. 4B, the recording/reading head 34 of the recording/reading apparatus 30 of this embodiment is arranged on the side of the guide pins 32.

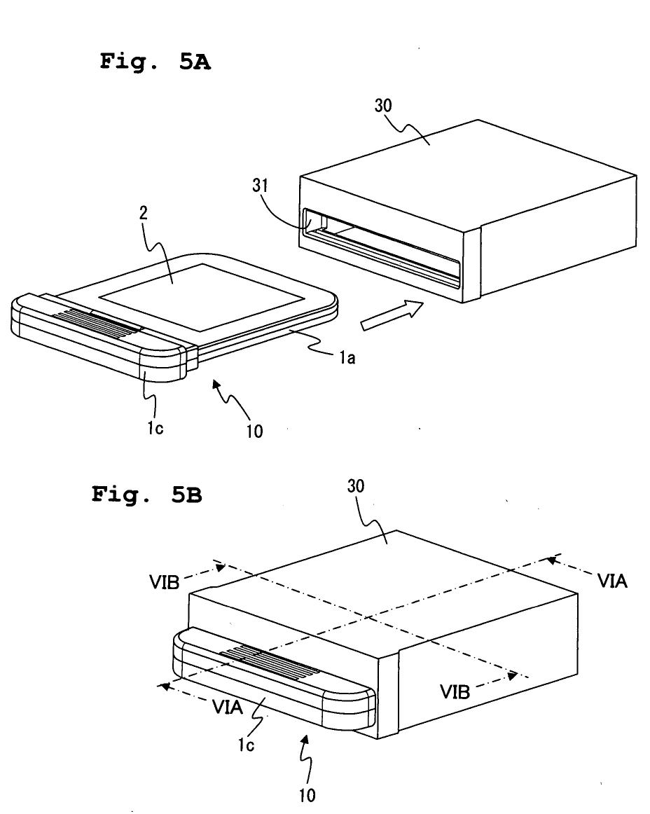

FIGS. 5A and 5B show the situations in which the holographic data storage medium 10 of this embodiment is actually loaded to the recording/reading apparatus 30. FIGS. 5A and 5B show the situations before the loading and after the loading of the holographic data storage medium 10 respectively. In this embodiment, as shown in FIGS. 5A and 5B, the holographic data storage medium 10 is inserted into the recording/reading apparatus 30 via the insert port 31 from the end surface of the insert portion 1a, which is dispose on the side opposite to the carrying portion 1c. As shown in FIG. 5B, the holographic data storage medium 10 is pushed into the recording/reading apparatus 30 until the insert portion 1a of the holographic data storage medium 10 is completely housed in the recording/reading apparatus 30, thereby completing the loading of the holographic data storage medium 10.

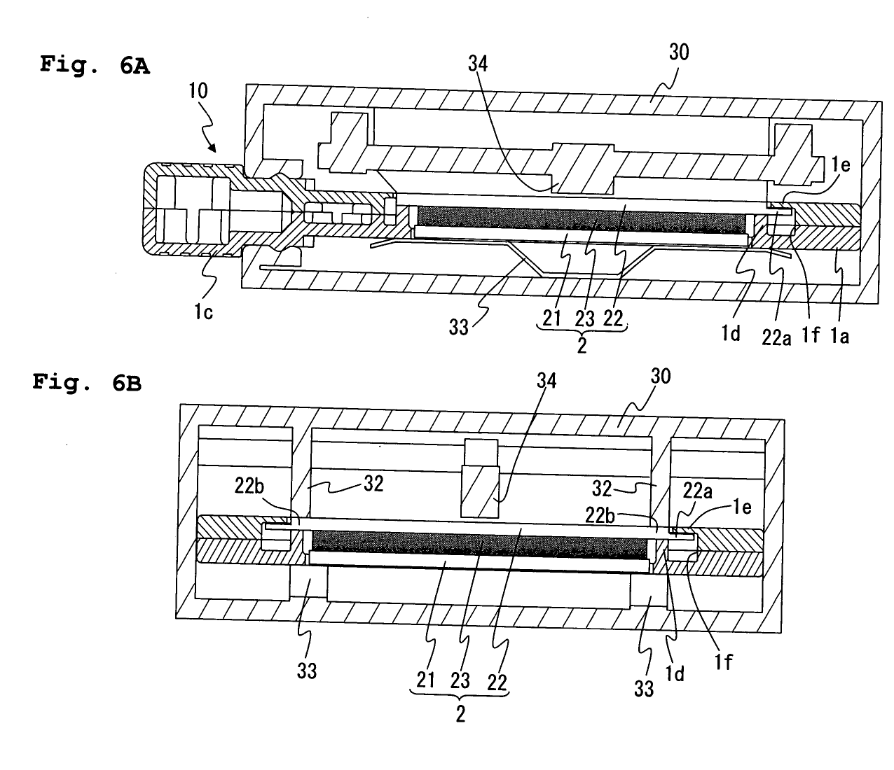

FIGS. 6A and 6B show the situation of the interior of the recording/reading apparatus 30 in the state shown in FIG. 5B (state in which the holographic data storage medium 10 is loaded to the recording/reading apparatus 30). FIG. 6A shows a sectional view taken along a line VIA-VIA shown in FIG. 5B, and FIG. 6B shows a sectional view taken along a line VIB-VIB shown in FIG. 5B. As shown in FIGS. 6A and 6B, the holographic data storage medium 10 is supported by being sandwiched between the pair of guide pins 32 and the pair of plate springs 33. This situation will be explained more specifically below. The guide pin 32 supports a part of the upper surface of the portion, of the second substrate 22 of the data storage medium body 2, which is disposed at the inside of the hold portion 22a (upper surface of the support portion 22b). The plate spring 33 supports a portion disposed in the vicinity of the lower surface area of the cartridge 1, which corresponds to the projection 1d for holding a part of the lower surface of the second substrate 22 (lower surface of the support portion 22b). That is, in this embodiment, the part of the upper surface of the outer edge portion of the second substrate 22 of the data storage medium body 2 (upper surface of the support portion 22b) is directly supported by the guide pin 32. The part of the lower surface of the outer edge portion of the second substrate 22 (lower surface of the support portion 22b) is indirectly supported by the plate spring 33 via the projection 1d of the cartridge 1. Accordingly, the holographic data storage medium 10 is supported in the recording/reading apparatus 30. As described above, in this embodiment, the step or the difference in height is provided between the lower surface of the first substrate 21 and the lower surface of the cartridge 1. Therefore, the lower surface of the first substrate 21 makes no contact with the plate spring 33. Therefore, in this embodiment, the second substrate 22 is directly supported (holographic-recording layer 23 is not supported directly), when the holographic data storage medium 10 is loaded to the recording/reading apparatus 30. Therefore, no pressure is applied to the holographic-recording layer 23. As a result, no stress arises in the holographic-recording layer 23. Therefore, it is possible to correctly record and reconstruct the information.

### First Modified Embodiment

In the holographic data storage medium of the present invention, as described above, one substrate (second substrate), which is included in the two substrates for holding the holographic-recording layer, is made larger than the other substrate (first substrate). Therefore, when the holographic data storage medium is constructed, the outer edge portion of the second substrate protrudes to the outside with respect to the first substrate. Therefore, the protruding outer edge portion of the second substrate is a portion which is irrelevant to the recording and reconstruction of the information. Therefore, this portion may be also carried by a user directly to load and unload the holographic recording medium to the recording/reading apparatus. In this first modified embodiment, an explanation will be made about an example of the holographic data storage medium having such a structure.

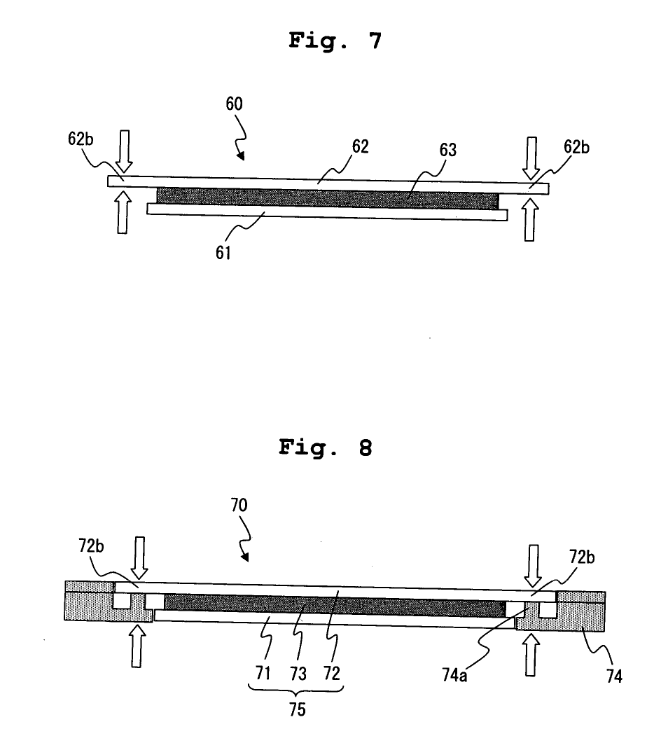

FIG. 7 shows a schematic sectional view illustrating a holographic data storage medium of the first modified embodiment. As shown in FIG. 7, the holographic data storage medium 60 of this embodiment includes a first substrate 61, a second substrate 62 which has a dimension larger than that of the first substrate 61, and a holographic-recording layer 63 which is formed between the first substrate 61 and the second substrate 62. In this embodiment, no cartridge was provided unlike the first embodiment. No hold portion was provided at the outer edge portion of the second substrate 62 as well. Except for the above, the arrangement is the same as or equivalent to that of the data storage medium body of the first embodiment. In this embodiment, a portion 62b of the second substrate 62, which is disposed outside the area opposed to the first substrate 61, is support portion which is supported, for example, by the positioning unit (for example, guide pin and plate spring) included in the recording/reading apparatus.

When the holographic data storage medium 60 of this embodiment is loaded to the recording/reading apparatus, parts of the upper and lower surfaces of the portions (support portion 62b) of the second substrate 62, which are disposed outside the first substrate 61, are directly supported, for example, by the positioning unit (for example, guide pin and plate spring) included in the recording/reading apparatus (blanked arrows shown in FIG. 7). Therefore, also in the case of the holographic data storage medium 60 of this embodiment, the holographic-recording layer 63 is not supported directly, for example, by the positioning unit, when the holographic data storage medium 60 is loaded to the recording/reading apparatus. Therefore, no pressure is applied to the holographic-recording layer 63, and no stress arises as well. Therefore, it is possible to record and reconstruct the information more correctly.

The holographic data storage medium 60 of this embodiment requires no cartridge unlike the first embodiment. Therefore, it is possible to further decrease the size. When the holographic data storage medium 60 of this embodiment is manufactured to have the same size as the whole size of the holographic data storage medium of the first embodiment, the recording area can be increased by an amount corresponding to the absence of the cartridge. Therefore, it is also possible to further increase the recording capacity. The holographic data storage medium 60 of this embodiment has the simple structure as compared with the first embodiment, and no cartridge is required. Therefore, the holographic data storage medium 60 of this embodiment is excellent in the mass productivity at the low cost.

### Second Modified Embodiment

FIG. 8 shows a schematic sectional view illustrating a holographic data storage medium of a second modified embodiment. In this embodiment, an explanation will be made about the modified embodiment of the holographic data storage medium provided with the cartridge, similarly to the first embodiment.

As shown in FIG. 8, the holographic data storage medium 70 of this embodiment includes a data storage medium body 75, and a cartridge 74 which holds the data storage medium body 75. In the case of the holographic data storage medium 70 of this embodiment, as shown in FIG. 8, the data storage medium body 75 is held such that lower surface of outer edge portion (support portion 72b) of a second substrate 72 is supported by upper surface of projection 74a formed on bottom surface of side wall portion which defines a through-hole of the cartridge 74. That is, in this embodiment, the structure, in which the outer edge portion of the second substrate is held by being sandwiched by the cartridge as in the first embodiment, is not adopted, but the structure, in which only the lower surface of the outer edge portion (support portion 72b) of the second substrate 72 is held by the cartridge 74, is adopted. Further, in this embodiment, the upper surface of the projection 74a of the cartridge 74 and the lower surface area of the outer edge portion (support portion 72b) of the second substrate 72 to make contact therewith, are adhered and fixed in order to reinforce the strength when any external force (for example, vibration or impact) is applied from the lower surface side of the holographic data storage medium 70. The data storage medium body 75 has the structure which is the same as or equivalent to that of the second modified embodiment. Except for the above, the structure is the same as or equivalent to that of the first embodiment. As shown in FIG. 8, the holographic data storage medium of this embodiment has the structure in which the first substrate 71 and the cartridge 74 make no contact with each other, similarly to the first embodiment.

When the holographic data storage medium 70 of this embodiment is loaded to the recording/reading apparatus, part of the upper surface of the portion (support portion 72b) of the second substrate 72 of the data storage medium body 75, which is disposed outside the first substrate 71, is directly supported, for example, by the positioning unit (for example, guide pin and plate spring) included in the recording/reading apparatus, and part of the lower surface of the portion (support portion 72b) of the second substrate 72, which is disposed outside the first substrate 71, is indirectly supported, for example, by the positioning unit via the projection 74a of the cartridge (blanked arrows shown in FIG. 8), similarly to the first embodiment. Therefore, also in the case of the holographic data storage medium 70 of this embodiment, the holographic-recording layer 73 is not supported directly, for example, by the positioning unit, when the holographic data storage medium 70 is loaded to the recording/reading apparatus. Therefore, no pressure is applied to the holographic-recording layer 73, and no stress arises as well. Therefore, it is possible to record and reconstruct the information more correctly.

### Third Modified Embodiment

The first embodiment and the second modified embodiment as described above are illustrative of the case in which the upper surface of the support portion of the second substrate is directly supported, for example, by the positioning unit of the recording/reading apparatus, and the lower surface of the support portion of the second substrate is indirectly supported via the cartridge. However, the present invention is not limited thereto. Only the cartridge may be directly supported by any positioning unit of the recording/reading apparatus, and the data storage medium body may be indirectly supported. In this embodiment, an explanation will be made about a case in which only the cartridge of the holographic data storage medium is directly supported by the positioning unit of the recording/reading apparatus.

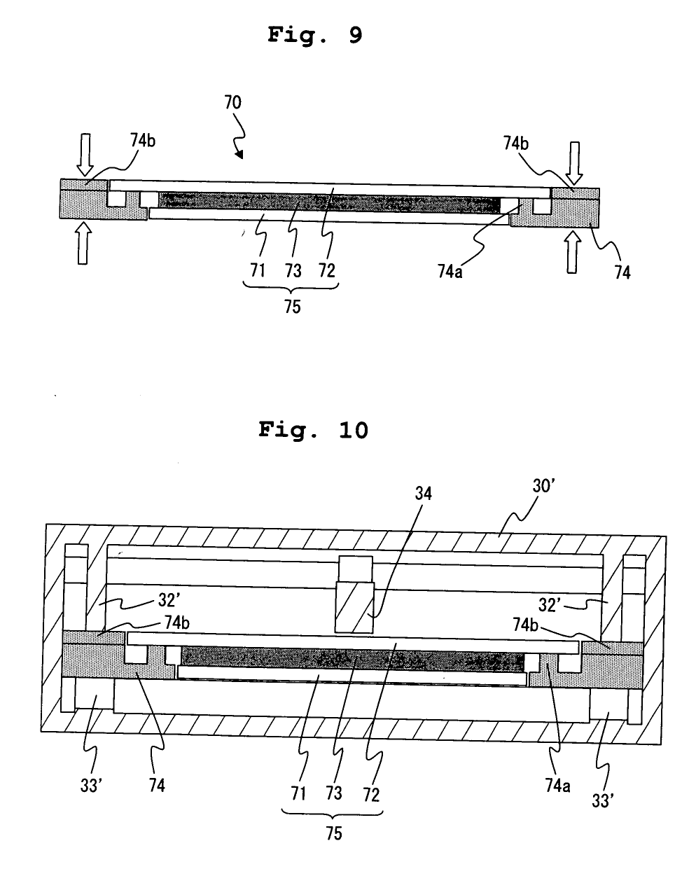

FIG. 9 shows a schematic sectional view illustrating a holographic data storage medium of this embodiment. As shown in FIG. 9, the holographic data storage medium 70 of this embodiment has the structure which is the same as or equivalent to that of the holographic data storage medium of the second modified embodiment. In the holographic data storage medium of this embodiment, upper and lower surfaces of outer edge portion 74b of a cartridge 74 are supported by positioning unit of a recording/reading apparatus (blanked arrows shown in FIG. 9). That is, in the case of the holographic data storage medium of this embodiment, the outer edge portion 74b of the cartridge 74 is the support portion.

FIG. 10 shows a situation in the recording/reading apparatus 30′ when the holographic data storage medium 70 of this embodiment is loaded to the recording/reading apparatus 30′. FIG. 10 corresponds to FIG. 6B of the first embodiment. In the case of the holographic data storage medium 70 of this embodiment, the outer edge portion 74b of the cartridge 74 is supported by the positioning unit (guide pins 32′ and plate springs 33′) of the recording/reading apparatus 30′. Therefore, in this embodiment, as shown in FIG. 10, the guide pin 32′ and the plate spring 33′ are moved to the position nearer to the side walls of the recording/reading apparatus 30′ than the exemplary arrangement (first embodiment) shown in FIG. 6B.

When the structure as described above is adopted, the second substrate of the data storage medium body does not make any direct contact with the positioning unit of the recording/reading apparatus as well, and the second substrate is indirectly supported by the positioning unit of the recording/reading apparatus via the cartridge. Therefore, no pressure is applied to the holographic-recording layer, and no stress arises as well. Therefore, it is possible to record and reconstruct the information more correctly.

### Fourth Modified Embodiment

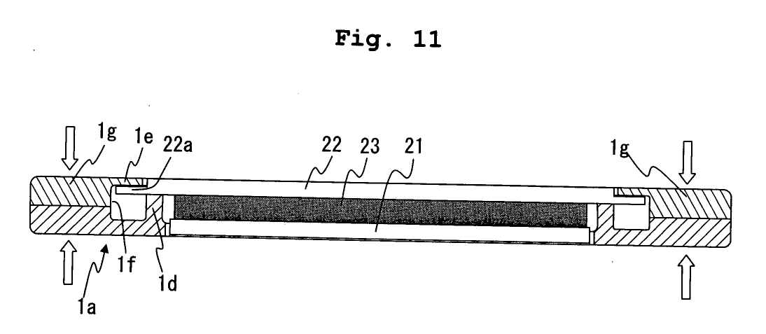

FIG. 11 shows a schematic sectional view illustrating a holographic data storage medium of this embodiment. As shown in FIG. 11, this embodiment adopts the structure which is the same as or equivalent to that of the holographic data storage medium of the first embodiment (the structure in which the outer edge portion of the second substrate is held by being sandwiched by the cartridge). In the holographic data storage medium of this embodiment, upper and lower surfaces of outer edge portions 1g of an insert portion 1a of a cartridge are supported by positioning unit of a recording/reading apparatus (blanked arrows shown in FIG. 11).

Even when the structure as described above is adopted, the second substrate of the data storage medium body does not make any direct contact with the positioning unit of the recording/reading apparatus. The second substrate of the data storage medium body is indirectly supported by the positioning unit of the recording/reading apparatus via the cartridge. Therefore, no pressure is applied to the holographic-recording layer, and no stress arises as well. Therefore, it is possible to record and reconstruct the information more correctly.

### Fifth Modified Embodiment

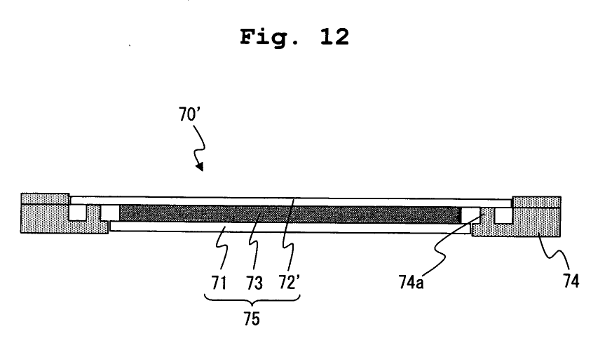

The holographic data storage media of the first embodiment and the first to fourth modified embodiments as described above are illustrative of the case in which the upper surface of the second substrate is flush with the upper surface of the insert portion of the cartridge which supports the second substrate. However, the present invention is not limited thereto. It is also allowable to provide any step or difference in height between the upper surface of the second substrate and the upper surface of the insert portion of the cartridge which holds the second substrate. An exemplary embodiment is shown in FIG. 12. In the case of a holographic data storage medium 70′ shown in FIG. 12, an upper surface of a second substrate 72′ is located nearer to a holographic-recording layer 73 than an upper surface of an insert portion 74 of a cartridge. This structure is constructed such that the second substrate 72′ is thinned, or the insert portion 74 of the cartridge is thickened. Other than the above, the structure is the same as or equivalent to those of the second and third modified embodiments. It is preferable that the step between the upper surface of the second substrate and the upper surface of the insert portion of the cartridge which holds the second substrate, is approximately the same as the step between the lower surface of the first substrate and the lower surface of the insert portion of the cartridge (about 0.1 to 0.6 mm). In this embodiment, the step was 0.1 to 0.2 mm.

In the case of the holographic data storage medium having the structure as described above, the second substrate does not make any direct contact with the desk or the like, for example, when the holographic data storage medium is placed on the desk or the like. Therefore, it is possible to improve the performance of protection of the holographic-recording layer.

### Sixth Modified Embodiment

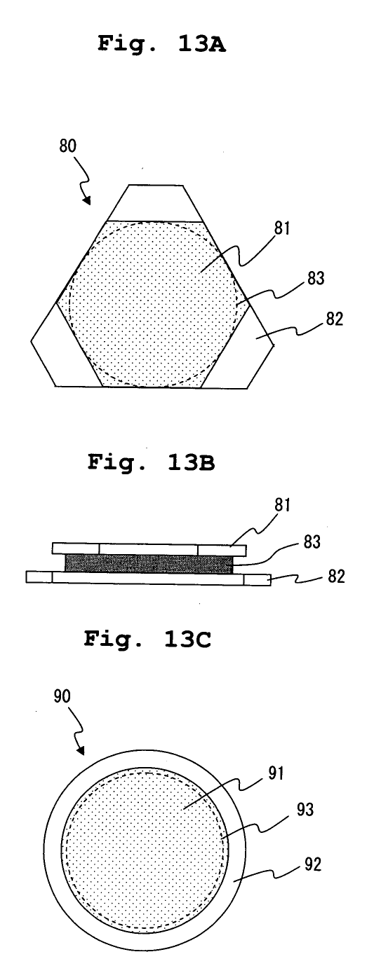

The holographic data storage media and the data storage bodies of the first embodiment and the first to fifth modified embodiments as described above are illustrative of the case in which the square plate-shaped members are used for both of the first substrate and the second substrate. However, the present invention is not limited thereto. The shapes of the first and second substrates may be appropriately changed depending on, for example, the application or purpose and the structure of the support mechanism included in the recording/reading apparatus. For example, it is also allowable that the shapes of the first substrate and the second substrate are, for example, rectangular, circular, elliptical, and polygonal shapes. The shapes of the first substrate and the second substrate may be different from each other as well. Examples of such arrangements are shown in FIGS. 13A, 13B, and 13C. Both of FIGS. 13A and 13C are plan views as viewed from the side of the first substrate having the small dimension. FIG. 13B shows a side view of FIG. 13A.

FIGS. 13A and 13B show a holographic data storage medium 80 including a hexagonal first substrate 81, a second substrate 82 which has a dimension larger than that of the first substrate 81 and which has a substantially triangular shape, and a circular holographic-recording layer 83 which is formed between the first substrate 81 and the second substrate 82. A holographic data storage medium shown in FIG. 13C includes a circular first substrate 91, a circular second substrate 92 which has a diameter larger than that of the first substrate 91, and a circular holographic-recording layer 93 which is formed between the first substrate 91 and the second substrate 92. The holographic data storage medium shown in FIGS. 13A and 13B is formed so that the respective centers of the first substrate, the second substrate, and the holographic-recording layer are aligned coaxially.

The first embodiment and the first to sixth modified embodiments as described above are illustrative of the holographic data storage medium in which the respective centers of the first substrate, the second substrate, and the holographic-recording layer are aligned coaxially. However, the present invention is not limited thereto. Any holographic data storage medium may be constructed so that the respective centers of the first substrate, the second substrate, and the holographic-recording layer are not aligned coaxially depending on, for example, the application or purpose and the structure of the support mechanism included in the recording/reading apparatus.

The first embodiment and the first to sixth modified embodiments as described above are illustrative of the case in which the support portion of the second substrate is flat. However, the present invention is not limited thereto. The shape of the support portion may be appropriately changed depending on, for example, the application or purpose and the structure of the support unit of the recording/reading apparatus. For example, the support portion may be recessed or concave.

In the case of the holographic data storage medium according to the present invention, no pressure is applied to the holographic-recording layer, and no stress arises as well, when the holographic data storage medium is loaded to the recording/reading apparatus. Further, it is also possible to realize the miniaturization. Furthermore, the same or equivalent effect is obtained, for example, even when the structure and the shape are changed depending on the application or purpose. Therefore, the holographic data storage medium according to the present invention is preferably adaptable to a variety of applications.

What is claimed is:

1. A holographic recording medium which is loaded to a recording/reading apparatus for recording and reconstructing information, the data storage medium comprising:
a first substrate;
a second substrate which has a dimension larger than that of the first substrate; and
a holographic-recording layer which is provided between the first substrate and the second substrate, wherein: the second substrate has a support portion which is disposed outside the first substrate and which is supported by the recording/reading apparatus.

2. The holographic recording medium according to claim 1, wherein the support portion is disposed on each of both surfaces of the second substrate.

3. The holographic recording medium according to claim 1, further comprising a cartridge which holds the second substrate.

4. The holographic recording medium according to claim 3, wherein a hold portion, which is held by the cartridge, is provided at an outer edge portion of the second substrate, the hold portion has a thickness which is thinner than a thickness of a central portion of the second substrate, a surface of the hold portion, which is disposed on a side opposite to a side of the holographic-recording layer, is located nearer to the holographic-recording layer than a surface of the central portion of the second substrate, which is disposed on the side opposite to the side of the holographic-recording layer, and both surfaces of the hold portion are held by the cartridge.

5. The holographic recording medium according to claim 3, wherein a surface of a central portion of the second substrate, which is disposed on a side opposite to a side of the holographic-recording layer, is flush with an outermost surface of the cartridge which is on a side of the second substrate.

6. The holographic recording medium according to claim 3, wherein a surface of the first substrate, which is disposed on a side opposite to a side of the holographic-recording layer, is located nearer to the holographic-recording layer than an outermost surface of the cartridge which is disposed on a side of the first substrate.

7. The holographic recording medium according to claim 3, wherein the first substrate makes no contact with the cartridge.

8. The holographic recording medium according to claim 3, wherein the cartridge holds only the second substrate.

9. The holographic recording medium according to claim 1, wherein the recording/reading apparatus includes a recording/reading head which records and reconstructs the information on the holographic recording medium, and the second substrate is located on a side of the recording/reading head when the holographic recording medium is loaded to the recording/reading apparatus.

10. The holographic recording medium according to claim 1, wherein the first substrate makes no contact with the recording/reading apparatus when the holographic recording medium is loaded to the recording/reading apparatus.

11. A holographic recording medium which is loaded to a recording/reading apparatus for recording and reconstructing information, the holographic recording medium comprising:
a first substrate;
a second substrate which has a dimension larger than that of the first substrate;
a holographic-recording layer which is provided between the first substrate and the second substrate; and
a cartridge which holds the second substrate, wherein: the cartridge has a support portion which supports the holographic recording medium in the recording/reading apparatus.

12. The holographic recording medium-according to claim 11, wherein a hold portion, which is held by the cartridge, is provided at an outer edge portion of the second substrate, the hold portion has a thickness thinner than a thickness of a central portion of the second substrate, a surface of the hold portion, which is disposed on a side opposite to a side of the holographic-recording layer, is located nearer to the holographic-recording layer than a surface of the central portion of the second substrate, which is disposed on the side opposite to the side of the holographic-recording layer, and both surfaces of the hold portion are held by the cartridge.

13. The holographic recording medium according to claim 11, wherein a surface of a central portion of the second substrate, which is disposed on a side opposite to a side of the holographic-recording layer, is flush with an outermost surface of the cartridge which is disposed on a side of the second substrate.

14. The holographic recording medium according to claim 11, wherein a surface, of the first substrate, which is opposite to the holographic-recording layer, is located nearer to the holographic-recording layer than an outermost surface, of the cartridge, which is on a side of the first substrate.

15. The holographic recording medium according to claim 11, wherein the first substrate makes no contact with the cartridge.

16. The holographic recording medium according to claim 11, wherein the cartridge holds only the second substrate.

17. The holographic recording medium according to claim 11, wherein the first substrate makes no contact with the recording/reading apparatus when the holographic recording medium is located to the recording/reading apparatus.
